(19) United States
(12) Patent Application Publication
(10) Pub. No.: US 2008/0270835 A1
(43) Pub. Date: Oct. 30, 2008

(54) Methods and Apparatus for Displaying Test Results and Alerts

(76) Inventors: Carli Connally, Fort Collins, CO (US); Kristin Petersen, Clifton Park, NY (US)

Correspondence Address: Gregory W. Osterloth;Holland & Hart, LLP, P.O. Box 8749, Denver, CO, 80201, US

(21) Appl. No.: 11/740,765

(22) Filed: Apr. 26, 2007

(51) Int. Cl. G06F 11/00

(52) U.S. Cl. 714/37

(57) ABSTRACT

In one embodiment, a sequence of test data items is parsed to identify test results, alerts, and context information that indicates how the test results and alerts correspond to a test execution sequence. The test results and at least some of the context information is displayed in a first display area of a graphical user interface (GUI); and the alerts and at least some of the context information is displayed in a second display area of the GUI. Other embodiments are also disclosed.

### BACKGROUND

When testing circuit devices such as system-on-a-chip (SOC) devices, various test data items may be logged, including test results and alerts. Typically, the test data items are displayed to a user by compiling them into a single list, and then displaying the list via a graphical user interface (GUI).

### BRIEF DESCRIPTION OF THE DRAWINGS

Illustrative embodiments of the invention are illustrated in the drawings, in which:

FIG. 1 illustrates an exemplary method for displaying test results and alerts; and

FIG. 2 illustrates an exemplary window of a GUI via which the method shown in FIG. 1 may be implemented.

### DETAILED DESCRIPTION

As a preliminary manner, it is noted that, in the following description, like reference numbers appearing in different drawing figures refer to like elements/features. Often, therefore, like elements/features that appear in different drawing figures will not be described in detail with respect to each of the drawing figures.

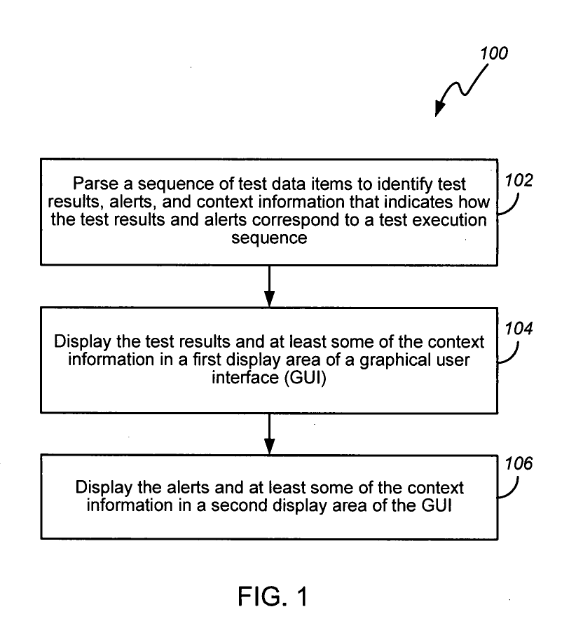

In accord with one embodiment of the invention, FIG. 1 illustrates a computer-implemented method 100 in which a sequence of test data items is parsed to identify test results, alerts, and context information that indicates how the test results and alerts correspond to a test execution sequence. See, block 102. In one embodiment, the test data items may pertain to tests of a system-on-a-chip (SOC) device, such as tests that have been executed by the V93000 SOC tester distributed by Verigy Ltd. However, the test data items could also pertain to tests that are executed by other sorts of testers, or tests that are executed on other sorts of circuit devices. In some cases, the test data items may be provided by, or derived from, one of the data formatters disclosed in the United States patent application of Connally, et al. entitled “Apparatus for Storing and Formatting Data” (Ser. No. 11/345,040). By way of example, the alerts may comprise 1) error alerts, such as alerts that indicate a failed test result, or alerts that indicate that a test has failed to execute, or 2) system alerts, such as alerts that indicate the status of a tester or its environment.

After or during the parsing of the test data items, the identified test results and at least some of the context information is displayed in a first display area of a graphical user interface (GUI), and the error alerts and at least some of the context information is displayed in a second display area of the GUI. See, blocks 104 and 106. By way of example, the first and second display areas may take forms such as 1) first and second panes of a single window of the GUI, or 2) first and second windows of the GUI.

The method 100 is useful in that it displays test results and alerts in separate display areas, but with context information that enables a user to determine how each of them (the test results and the alerts) relates to a test execution sequence. Because there are typically far fewer alerts than there are test results, the method 100 enables a user to find the alerts much more quickly than in the past, without having to hunt for them amongst thousands or even millions of test results. Separating the displays of the alerts and test results also enables a user to more easily assess failures on a global level.

In some cases, the first and second display areas provided by the method 100 may be formatted differently, to better convey the test results and alerts to a user. For example, the test results and context information displayed in the first display area may be displayed via a table, with each of the test results and context information forming an entry (e.g., row) in the table. In contrast, the alerts and context information displayed in the second display area may be displayed via a list. In one embodiment, lines of the list may be indented to distinguish different levels of related context information.

The method 100 shown in FIG. 1 may be implemented by means of computer-readable code stored on computer-readable media. The computer-readable media may include, for example, any number or mixture of fixed or removable media (such as one or more fixed disks, random access memories (RAMs), read-only memories (ROMs), or compact discs), at either a single location or distributed over a network. The computer readable code will typically comprise software, but could also comprise firmware or a programmed circuit.

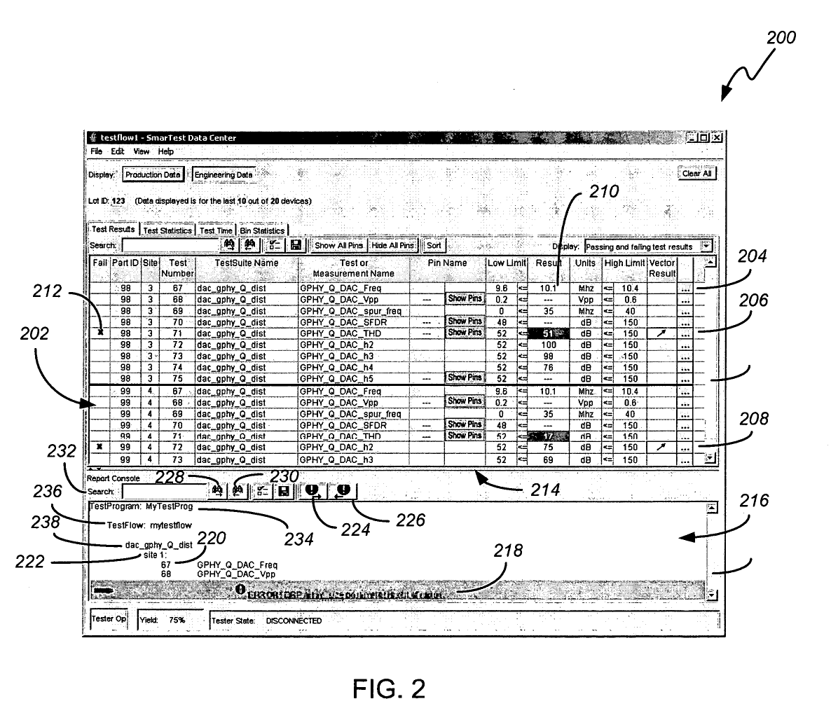

FIG. 2 illustrates an exemplary window (or screen) of a GUI 200 via which the method 100 may be implemented. As test data items are being parsed to identify test results, alerts, and context information, the test results and context information are used to form a plurality of test data entries (such as entries 204, 206, 208) that are displayed in a first display area 202 (e.g., a first window pane) of the GUI 200. By way of example, each test data entry 204, 206, 208 may comprise several items of contextual information, including:
1) test result identifiers, such as a “Test Number”, a “Test or Measurement Name”, and a “TestSuite Name” that identifies a test suite to which the test name and number belong;
2) information identifying the test resources via which a test result was acquired (e.g., a test “Site” number); and
3) information identifying the device and pin for which a test result was acquired (e.g., a device “Part ID”, and a device “Pin Name”).

The test result of each test data entry 204, 206, 208 may be conveyed in various ways, including, as a value 210 in a “Result” field and/or a check 212 in a “Fail” field (e.g., for those tests that have failed). For measurement-type test results, “Low Limit” and “High Limit” fields may also be populated.

As further shown in FIG. 2, each of the test data entries 204, 206,208 may be displayed as a line of a table 214, with different lines of the table corresponding to different ones of the test data entries 204, 206, 208. For purposes of this description, a “table” is defined to be either an integrated structure wherein data is displayed in tabular form, or multiple structures that, when displayed side-by-side, enable a user to review information in rows and columns.

FIG. 2 also illustrates a second display area 216 (e.g., a second window pane), in which alerts (e.g., alert 218) and their contextual information (e.g., test number 220, and test site number 222) is displayed. By way of example, the contextual information 220, 222 and alerts 218 are displayed via a list (or outline), with lines of the list being indented to distinguish different levels of related context information.

The contextual information displayed in the display area 216 may take various forms, and in some cases may comprise any or all of: test program identifiers 234, test identifiers 220, and other information. In one embodiment, different levels of a contextual outline displayed in the area 216 may correspond to: test program identifiers 234, testflow identifiers 236, test suite identifiers 238, test site identifiers (e.g., test site number 222), test identifiers (e.g., test numbers 220), and test bin information (not shown). The alerts 218 displayed in the display area 216 may also take various forms, such as user alerts, error alerts, warnings, and test execution mode messages (e.g., messages related to switches between production and debug test execution modes).

In some cases, some or all of the context information displayed in the areas 202 and 216 of the GUI 200 may be the same. However, it is envisioned that the type and format of the context information displayed in the two areas 202, 216 will often differ.

As previously mentioned, the alerts displayed in the area 216 may take different forms, including those of error alerts and system alerts. In addition, the formats of the alerts may take different forms. For example, alerts may comprise messages (e.g., an error message 218 indicating that a “DSP array size parameter is out of range”) or codes (e.g., an error code “32”).

Preferably, the display areas 202 and 216 are displayed during execution of a plurality of tests on which the test data entries 204, 206, 208 are based (i.e., during test of a device under test). Test results and alerts can then be displayed via the display areas 202 and 216 as they are acquired, and a user can be provided “real-time” displays of test results and alerts. Alternately, device testing can be completed, and logs of test results, alerts, and their context information can be saved to volatile or non-volatile storage (e.g., memory or a hard disk). The test results, alerts 218 and context information can then be read and displayed in succession via the display areas 202 and 216 (i.e., not in real-time).

Typically, the test data entries 204, 206, 208 and alerts 218 that are displayed at any one time represent only some of the test data entries alerts that are generated during execution of a plurality of tests. As a result, one or more user-operable navigation mechanisms such as scroll bars 220, 222 may be provided via the GUI 200, thereby enabling a user to navigate to different test data entries or alerts.

The scroll bar 220 is associated with the display area 202, and the scroll bar 222 is associated with the display area 216. In one embodiment, scrolling activity within the display areas 202 and 216 may be synchronized, such that navigation to a particular test data entry in the display area 202 causes the display area 216 to display alerts (if any) that are proximate to the context of the test data entries shown in the display area 202. Similarly, navigation to a particular alert in the display area 216 may cause the display area 202 to display one or more test results (or test data entries) that are proximate to the context of the alerts shown in the display area 216. In an alternate embodiment, the scroll bars 220 and 222 function independently, and the display areas 202 and 216 are not synchronized.

In addition (or in lieu of) the scroll bar 222, other user-operable navigation mechanisms may be associated with the display area 216. For example, the GUI 200 may provide one or more buttons 224, 226 for navigating from one alert to another. These buttons may include a button 224 for navigating to a next alert, and a button 226 for navigating to a previous alert. Alternately, different sets of buttons could be provided for navigating different types of alerts (e.g., separate sets of buttons for navigating error versus system alerts), or a single button could be provided for simply jumping to the next alert. A pair of buttons 228, 230 may also be associated with a text field 232, and may be used to navigate to alerts containing the term or terms entered in the text field 232. As with the scroll bar 222, the buttons 224, 226, 228, 230 for navigating from one alert to another may, or may not, be configured to operate independently from any mechanisms 220 for navigating from one test result (or test data entry) to another.

In one embodiment, the alerts that are displayed via the display area 216 may be emphasized by highlighting them, bolding them or underlying them. Alerts may also be emphasized in other ways, or in combinations of ways. An alert may also be emphasized upon a user's navigation to the alert. Or, an alert that has already been emphasized in one manner may be emphasized in a different manner upon a user's navigation to the alert.

What is claimed is:

1. A computer-implemented method, comprising:
parsing a sequence of test data items to identify test results, alerts, and context information that indicates how the test results and alerts correspond to a test execution sequence;
displaying the test results and at least some of the context information in a first display area of a graphical user interface (GUI); and
displaying the alerts and at least some of the context information in a second display area of the GUI.

2. The method of claim 1, further comprising:
providing, via the GUI, at least one user-operable navigation mechanism for navigating from one alert to another.

3. A computer-implemented method, comprising:
parsing a sequence of test data items to identify test results, error alerts, and context information context information that indicates how the test results and error alerts correspond to a test execution sequence;
displaying the test results and at least some of the context information in a first display area of a graphical user interface (GUI); and
displaying the error alerts and at least some of the context information in a second display area of the GUI.

4. The method of claim 3, further comprising:
providing, via the GUI, at least one user-operable navigation mechanism for navigating from one error alert to another.

5. The method of claim 4, further comprising:
upon use of the at least one user-operable navigation mechanism, emphasizing an error alert to which a user has navigated.

6. The method of claim 5, wherein emphasizing the error alert to which the user has navigated comprises highlighting the error alert to which the user has navigated.

7. The method of claim 4, wherein use of the at least one user-operable navigation mechanism to navigate to a particular error alert causes the first display area to display one or more test results that are proximate to a context of the particular error alert.

8. The method of claim 3, further comprising:
providing, via the GUI, at least one user-operable navigation mechanism for navigating from one test result to another, wherein the navigation mechanisms for navigating the error alerts and the test results operate independently of one another.

9. The method of claim 3, further comprising:
respectively displaying the test results and the error alerts, in the first and second display areas, while parsing the sequence of test data items.

10. The method of claim 3, wherein the context information comprises test program identifiers and test identifiers.

11. The method of claim 3, wherein at least some of the context information displayed in the first and second displays is common to the first and second displays.

12. The method of claim 3, wherein the first and second display areas are formatted differently.

13. The method of claim 3, wherein the test results and context information displayed in the first display area are displayed via a table, and wherein the error alerts and context information displayed in the second display area are displayed via a list.

14. The method of claim 13, wherein lines of the list are indented to distinguish different levels of related context information.

15. The method of claim 3, further comprising:
parsing the sequence of test data items to identify system alerts other than error alerts, and context information that indicates how the system alerts correspond to the test execution sequence; and
displaying the system alerts, and at least some of the context information that indicates how the system alerts correspond to the test execution sequence, in the second display area of the GUI.

16. Apparatus, comprising:
computer-readable media;
computer-readable code, stored on the computer-readable media, including,
code to cause a computer to parse a sequence of test data items to identify test results, error alerts, and context information that indicates how the test results and error alerts correspond to a test execution sequence;
code to cause the computer to display the test results and at least some of the context information in a first display area of a graphical user interface (GUI); and
code to cause the computer to display the error alerts and at least some of the context information in a second display area of the GUI.

17. The apparatus of claim 16, further comprising:
code to cause the computer to provide, via the GUI, at least one user-operable navigation mechanism for navigating from one error alert to another.

18. The apparatus of claim 17, wherein the at least one user-operable navigation mechanism comprises a button for navigating to a next error, and a button for navigating to a previous error.

19. The apparatus of claim 17, further comprising:
code to, upon use of the at least one user-operable navigation mechanism, cause the computer to emphasize an error alert to which a user has navigated.

20. The apparatus of claim 17, wherein the at least one user-operable navigation mechanism comprises a scroll bar.

21. The apparatus of claim 16, wherein the context information comprises test program identifiers and test identifiers.

22. The apparatus of claim 16, wherein the code causes the test results and context information to be displayed via a table in the first display area, and wherein the code causes the error alerts and context information to be displayed via a list in the second display area.

23. The apparatus of claim 22, wherein code indents lines of the list to distinguish different levels of related context information.

24. The apparatus of claim 16, wherein the first and second display areas are first and second panes of a window of the GUI.

25. The apparatus of claim 16, wherein the first and second display areas are first and second windows of the GUI.

26. The apparatus of claim 16, further comprising:
code to cause the computer to parse the sequence of test data items to identify system alerts other than error alerts, and context information that indicates how the system alerts correspond to the test execution sequence; and
code to cause the computer to display the system alerts, and at least some of the context information that indicates how the system alerts correspond to the test execution sequence, in the second display area of the GUI.

27. The apparatus of claim 16, wherein the test data items pertain to tests of a system-on-a-chip (SOC) device.
